(19) United States
(12) Patent Application Publication
(10) Pub. No.: US 2026/0202517 A1
(43) Pub. Date: Jul. 16, 2026

(54) IMPROVING SIGNAL-TO-NOISE RATIO IN LIGHT DETECTION AND RANGING BY OPTICAL PREAMPLIFICATION

(71) Applicant: Lumentum Operations LLC, San Jose, CA (US)

(72) Inventors: Jeremy Gulanes PORQUEZ, Nepean (CA); Alan HNATIW, Ottawa (CA)

(21) Appl. No.: 19/089,695

(22) Filed: Mar. 25, 2025

Related U.S. Application Data
(60) Provisional application No. 63/745,560, filed on Jan. 15, 2025.

(51) Int. Cl. G01S 7/481; G01S 7/484; G01S 7/4861; G01S 7/489; G01S 17/42; G01S 17/66; G01S 17/894

(52) U.S. Cl. CPC G01S 7/4817; G01S 7/484; G01S 7/4861; G01S 7/489; G01S 17/42; G01S 17/66; G01S 17/894

(57) ABSTRACT

A beam scanning system includes a light transmitter configured to transmit a light beam; a beam scanner configured to receive the light beam from the light transmitter and direct the light beam along a transmission path according to a two-dimensional (2D) scanning pattern; and a receiver configured to receive a reflected light beam that corresponds to the light beam transmitted by the light transmitter. The receiver includes an optical preamplifier configured to apply an optical gain to the reflected light beam to produce a gain-compensated light beam; and a detector comprising one or more sensor elements configured to acquire measurements of the gain-compensated light beam. The optical preamplifier is configured to apply the optical gain to the reflected light beam such that the gain-compensated light beam is within a dynamic range of the one or more sensor elements.

### CROSS-REFERENCE TO RELATED APPLICATION

This Patent Application claims priority to U.S. Provisional Ser. No. 63/745,560, filed on Jan. 15, 2025, and entitled “IMPROVING LIDAR SIGNAL-TO-NOISE RATIO BY OPTICAL PREAMPLIFICATION.” The disclosure of the prior Application is considered part of and is incorporated by reference into this Patent Application.

### TECHNICAL FIELD

The present disclosure relates generally to light detection and ranging (LIDAR) and to improving signal-to-noise ratio (SNR).

### BACKGROUND

A scanning system may use two-dimensional (2D) scanning to scan one or more light beams within a field-of-view (FOV) according to a scanning pattern. The scanning system may use two scanning axes, including a first scanning axis that is configured to steer the one or more light beams in a first direction at a first scanning frequency and a second scanning axis that is configured to steer the one or more light beams in a second direction at a second scanning frequency. The second scanning axis is typically perpendicular to the first scanning axis. Transmitted light beams may be reflected back to the scanning system from one or more objects in the FOV as reflected light beams. A three-dimensional (3D) image of a scanned scene or a scanned object can then be generated based on distance measurements corresponding to the transmitted/reflected light beams. Additionally, or alternatively, the reflected light beams may be used by the scanning system to detect objects within the FOV for further processing.

### SUMMARY

In some implementations, a beam scanning system includes a light transmitter configured to transmit a light beam; a beam scanner configured to receive the light beam from the light transmitter and direct the light beam along a transmission path according to a 2D scanning pattern; and a receiver configured to receive a reflected light beam that corresponds to the light beam transmitted by the light transmitter, the receiver comprising: an optical preamplifier configured to apply an optical gain to the reflected light beam to produce a gain-compensated light beam; and a detector comprising one or more sensor elements configured to acquire measurements of the gain-compensated light beam, wherein the optical preamplifier is configured to apply the optical gain to the reflected light beam such that the gain-compensated light beam is within a dynamic range of the one or more sensor elements.

In some implementations, a method of beam scanning includes transmitting, by a light transmitter, a light beam; directing, by a beam scanner, the light beam along a transmission path according to a 2D scanning pattern; receiving, by a receiver, a reflected light beam that corresponds to the light beam transmitted by the light transmitter; applying, by an optical preamplifier of the receiver, an optical gain to the reflected light beam to produce a gain-compensated light beam; and acquiring, by a detector of the receiver, measurements of the gain-compensated light beam, wherein applying the optical gain includes applying the optical gain to the reflected light beam such that the gain-compensated light beam is within a dynamic range of the detector.

### BRIEF DESCRIPTION OF THE DRAWINGS

FIG. 1 is a schematic block diagram of a 2D scanning system according to one or more implementations.

FIG. 2 shows a system according to one or more implementations.

FIG. 3 shows a power map of a target object.

FIG. 4 shows a diagram illustrating a method of scanning a target object using optical preamplification.

FIG. 5 is a flowchart of an example process associated with improving signal-to-noise ratio in light detection and ranging by optical preamplification.

### DETAILED DESCRIPTION

The following detailed description of example implementations refers to the accompanying drawings. The same reference numbers in different drawings may identify the same or similar elements.

A 2D scan may be used to scan a 3D scene or a 3D object. While light may be scanned in two dimensions, a third dimension (e.g., a depth dimension) may be obtained from distance measurements. Light may be transmitted as pulsed light beams or as a continuous-wave light beam (e.g., a continuous-wave light beam with changing frequency or changing amplitude). A beam scanner, such as a movable scanning mirror, may be configured to direct one or more light beams over a range of angles into a field-of-view based on a scanning pattern defined by one or more parameters. A reflected light beam, reflected by an object, is returned to a detector for measurement. The distance measurements may be performed based on a time-of-flight of transmitted and reflected light beams.

In the field of optical metrology, where light is used to measure distances, free space propagation can lead to significant attenuation (e.g., signal losses). In some cases, attenuation can be as high as 20 dB over a meter of propagation. Put another way, while light is widely used for information transmission, light loses intensity and fidelity over long distances through various media, resulting in noisier signal reception (e.g., a lower signal-to-noise ratio (SNR)). Signal losses and/or lower SNR may make it difficult for the detector to detect a useable signal. To compensate, strategies include the use of high initial optical power, employing optics with strict tolerances, or simply by moving a target object closer to an optical metrology system. While these approaches can improve signal detection, they also pose potential eye hazards and limit sensor placement versatility. Material properties, such as angle, color, and surface texture, can also introduce inconsistencies in a returned (reflected) light signal, leading to undetectable readings or detector saturation. A large variance in returned light signals can either render readings undetectable or saturate the detector.

Some implementations are directed to improving SNR of a returned light signal (e.g., a reflected light beam) by optical preamplification prior to the returned light signal reaching a detector. Optical preamplification may be performed in a receiver path of a receiver. The optical preamplification may boost the returned light signal to be within a dynamic range of the detector, thereby reducing or eliminating a need for other compensation strategies. Thus, the optical preamplification may enhance the receiver's ability to accurately interpret information encoded onto the returned light signal by boosting the returned light signal in the receiver path prior to the detector.

In some implementations, a beam scanning system includes receiver configured with optical preamplification. The receiver may include an optical preamplifier configured to apply an optical gain to a reflected light beam to produce a gain-compensated light beam; and a detector comprising one or more sensor elements (e.g., photodetectors) configured to obtain measurements of the gain-compensated light beam by converting the gain-compensated light beam into equivalent electric signals. The optical preamplifier may apply the optical gain to the reflected light beam such that the gain-compensated light beam is within a dynamic range of the one or more sensor elements.

In LIDAR, “dynamic range” refers to a ratio between strongest and weakest detectable signal levels that detector can accurately measure, essentially representing a range of intensities the detector can capture without saturation or significant noise, allowing the detector and/or a processing component to discern details across different reflectivity levels in a scene. A wider dynamic range typically means the detector can detect both very bright and very dim reflections from targets within a scan.

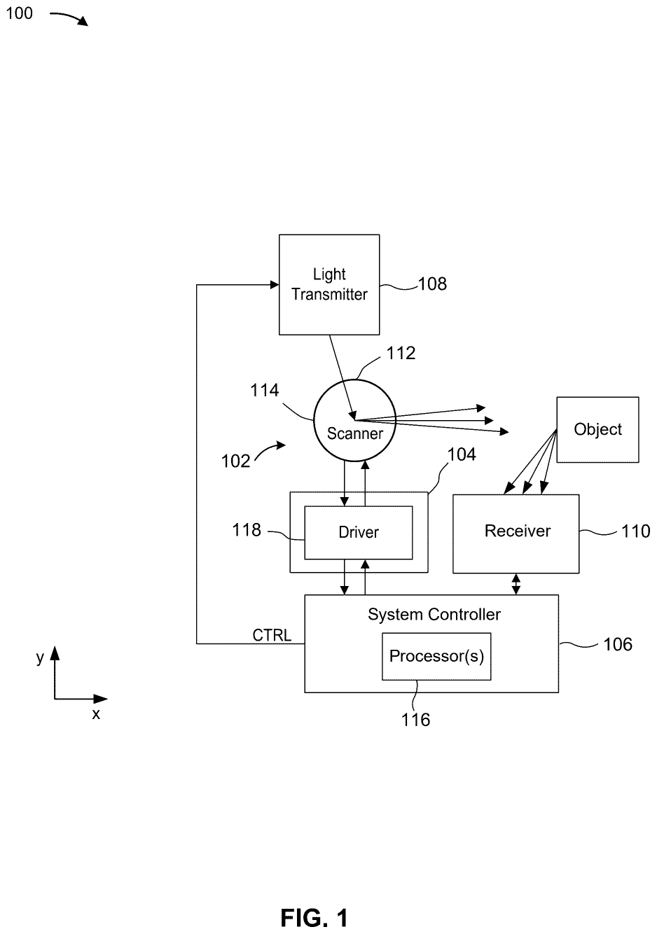

FIG. 1 is a schematic block diagram of a 2D scanning system 100 according to one or more implementations. In some implementations, the 2D scanning system 100 may be implemented in a LIDAR system. In particular, the 2D scanning system 100 includes a beam scanner 102 configured to steer or otherwise deflect light beams according to a 2D scanning pattern for scanning 3D objects. The 2D scanning system 100 further includes a driver system 104, a system controller 106, and a light transmitter 108, and a receiver 110.

The beam scanner 102 may be arranged to receive one or more transmitted light beams (e.g., optical signals) from the light transmitter 108 and steer (scan) the one or more transmitted light beams into the field-of-view to perform a scanning of the environment. In the example shown in FIG. 1, the beam scanner 102 may be a mechanical moving mirror and may be configured to rotate or oscillate via rotation about two scanning axes that are typically orthogonal to each other. For example, the two scanning axes may include a first scanning axis 112 that enables the beam scanner 102 to steer light in a first scanning direction (e.g., an x-direction) and a second scanning axis 114 that enables the beam scanner 102 to steer light in a second scanning direction (e.g., a y-direction). As a result, the beam scanner 102 can direct light beams over a range of angles in two dimensions according to the 2D scanning pattern. Thus, the beam scanner 102 can be used to scan the field-of-view in both scanning directions by changing an angle of deflection of the beam scanner 102 on each of the first scanning axis 112 and the second scanning axis 114.

In some implementations, the beam scanner 102 may be a galvanometer scanner. The galvanometer scanner may include a shaft for each scanning axis, a first galvanometer-based scanning motor that drives a rotation of a first shaft associated with the first scanning axis 112, a second galvanometer-based scanning motor that drives a rotation of a second shaft associated with the second scanning axis 114, an optical mirror mounted to both the first shaft and the second shaft, and a detector that provides positional feedback (e.g., an actual angle measurement for each scanning axis or a vector measurement) to the system controller 106. The driver system 104 may include a first servo driver for driving the first galvanometer-based scanning motor, and a second servo driver for driving the second galvanometer-based scanning motor. Each servo driver may generate a driving signal (e.g., a drive current) based on a command position (e.g., an angle setpoint) that is provided to the servo driver by a control loop. Each servo driver may supply the driving signal to a respective galvanometer-based scanning motor. The system controller 106 may monitor a difference representing an error between the command position (e.g., the angle setpoint) and an actual position (e.g., the actual angle measurement) to adjust the command position based on the difference.

In some implementations, the beam scanner 102 may include two mechanical moving mirrors arranged in series along a transmission path of a light beam such that a first mechanical moving mirror first receives a light beam and steers the light beam according to a respective deflection angle and a second mechanical moving mirror receives the light beam from the first mechanical moving mirror and steers the light beam according to a respective deflection angle. The two mechanical moving mirrors may each have a single scanning axis. For example, the first mechanical moving mirror may be associated with the first scanning axis 112, and the second mechanical moving mirror may be associated with the second scanning axis 114. As a result, the two mechanical moving mirrors may operate together to steer the light beam generated by the light transmitter 108 at an output deflection angle. In this way, the two mechanical moving mirrors can direct the light beam at a desired coordinate in the field-of-view.

A scan can be performed to illuminate an area referred to as a field-of-view. The scan, such as an oscillating horizontal scan (e.g., from left to right and right to left of a field-of-view), an oscillating vertical scan (e.g., from bottom to top and top to bottom of a field-of-view), or a combination thereof (e.g., a Lissajous scan or a raster scan) can illuminate the field-of-view in a continuous scan fashion. In some implementations, the scan may be targeted on a specific object (e.g., a target object) for scanning the target object. For example, a scan of a target object may be used in manufacturing to determine whether the target object is free of manufacturing defects. In some implementations, the 2D scanning system 100 may be configured to transmit successive light beams (e.g., as successive light pulses) in different scanning directions to scan the field-of-view. The beam scanner 102 can direct a transmitted light beam at a desired 2D measurement coordinate (e.g., an x-y coordinate) in the field-of-view, controlled by the system controller 106.

The light transmitter 108 may include one or more light sources, such as one or more laser diodes or one or more light emitting diodes, for generating one or more light beams. In some implementations, the light transmitter 108 may be configured to transmit a light beam as a continuous-wave light beam (e.g., frequency-modulated continuous wave (FMCW) or amplitude-modulated continuous wave (AMCW)) as the beam scanner 102 changes a transmission direction in order to target different 2D measurement coordinates. Control parameters of a continuous-wave modulation, such as amplitude or frequency, implemented by the light transmitter 108 may be configured according to a control signal CTRL received from the system controller 106. Alternatively, the light transmitter 108 may be configured to sequentially transmit a plurality of light beams (e.g., light pulses) as the beam scanner 102 changes a transmission direction in order to target different 2D measurement coordinates. A transmission sequence of the plurality of light beams and a timing thereof may be implemented by the light transmitter 108 according to the control signal CTRL received from the system controller 106.

A transmitted light beam may be backscattered by one or more objects back toward the 2D scanning system 100 as a reflected light beam, where the reflected light beam is detected by the receiver 110 at a receiver side of the 2D scanning system 100. For example, the receiver 110 may include a detector (e.g., a sensor) that includes one or more sensor elements, such as one or more photodetectors. The detector may include a photodetector array that converts each reflected light beam into one or more electric signals (e.g., current signals or voltage signals) that may be further processed by the 2D scanning system 100 to generate object data or an image. In addition, the receiver 110 may include an optical preamplifier configured to apply an optical gain to the reflected light beam to produce a gain-compensated light beam. The optical preamplifier may be arranged in a receiver path of the receiver 110, upstream from the detector. Thus, the detector may receive the gain-compensated light beam from the optical preamplifier and acquire measurements of the gain-compensated light beam. The optical preamplifier may apply the optical gain to the reflected light beam such that the gain-compensated light beam is within a dynamic range of the detector (e.g., within a dynamic range of the sensor elements).

In some implementations, the receiver 110 is a coherent receiver that utilizes coherent detection, and the transmitted light beam is an AMCW light beam (e.g., the reflected light beam is an AMCW light beam).

The optical preamplifier may introduce spectral noise, such as broadband noise, into the gain-compensated light beam. As a result, the receiver 110 may include an optical filter arranged between the optical preamplifier and the detector. The optical filter may receive the gain-compensated light beam and filter out the broadband noise produced by the optical preamplifier.

The receiver 110 may further include one or more acquisition elements coupled to the detector and may be configured to acquire measurements of the one or more electric signals (e.g., of the reflected light beam) based on a measurement acquisition scheme (e.g., temporal or angular). In some implementations, the one or more acquisition elements may be analog-to-digital converters (ADCs) that have a controlled acquisition time. In some implementations, the receiver 110 may include transimpedance amplifiers (TIAs) that convert the photocurrents from the detector into corresponding voltages, and the one or more acquisition elements sample the corresponding voltages. The acquisition time may be controlled by the system controller 106. An acquisition time may be a sampling time at which an ADC samples an electric signal to acquire a digital sample or digital value of the electric signal. For example, based on a temporal acquisition scheme, the one or more acquisition elements may acquire measurements at regular time intervals. Based on an angular acquisition scheme, the one or more acquisition elements may acquire measurements at regular angular intervals of the beam scanner 102. In such implementations, a desired 2D measurement coordinate may correspond to a particular acquisition time in a temporal domain or a particular acquisition angle of the beam scanner 102 in an angular domain.

The system controller 106 may receive electrical signals from the receiver 110 (e.g., from the one or more acquisition elements) and perform signal processing on the measurements (e.g., on the digital signals) for object feature detection. In some implementations, the one or more acquisition elements may be implemented in the system controller 106 instead of the receiver 110. For continuous wave modulation, such as that used for an AMCW light beam, a radio frequency (RF) signal may be encoded onto an optical signal (e.g., a laser beam). A delay of a detected wave after reflection is measured at the receiver. In the case of AMCW, an intensity pattern, such as and RF pattern of the RF signal, is encoded on a transmitted optical power of the transmitted light beam. A free-space path encodes a phase shift on the RF signal, which can be detected by measuring an intermediate frequency after mixing a received intensity signal with a version of the RF signal representing a known delay, used as a reference signal. The known delay may be zero or non-zero. The “representing” is intended to accommodate non-zero delays that are either actual or synthesized (and may in fact only be “known” because it is determined upon reception).

A digital signal provided by an acquisition element may be encoded with the RF pattern that has been phase shifted based on the distance to the object. Thus, the distance can be determined from the measured phase shift. This is in contrast to pulsed modulation, in which a system measures distance to a 3D object by measuring the absolute time that a light pulse takes to travel from a source into the 3D scene and back, after reflection. The receiver 110 and/or the system controller 106 may include one or more processors 116 configured to, based on the measurements, calculate distances to an object from which the reflected light beam is reflected.

The driver system 104 may be configured to generate driving signals (e.g., actuation signals) to drive the beam scanner 102 about the first scanning axis 112 and the second scanning axis 114. In particular, the driver system 104 may be configured to apply the driving signals to an actuator structure of the beam scanner 102. In some implementations, the driver system 104 includes a driver 118 configured to drive the beam scanner 102 about the first scanning axis 112 and the second scanning axis 114. In implementations in which the beam scanner 102 is used as an oscillator, the driver 118 may be configured to drive an oscillation of the beam scanner 102 about the first scanning axis 112 at a first frequency, and drive an oscillation of the beam scanner 102 about the second scanning axis 114 at a second frequency.

The driver 118 may be configured to receive feedback information from the beam scanner 102, such as rotational position information. Thus, the driver 118 may include a position tracking circuit configured to monitor a transmission direction of the beam scanner 102 within the 2D scanning pattern and generate transmission direction information based on the transmission direction. For example, the driver 118 may detect a capacitance or a current of the beam scanner 102 that changes as a rotational position of the beam scanner 102 changes. Thus, the driver 118 may use the capacitance or the current of the beam scanner 102 as the rotational position information for monitoring the transmission direction of the beam scanner 102 and generate the transmission direction information. In some implementations, the driver 118 may provide the rotational position information to the system controller 106, and the system controller 106 may monitor the transmission direction of the beam scanner 102 based on the rotational position information to generate the transmission direction information. In other words, in some implementations, the driver 118 and the system controller 106 may form the position tracking circuit.

In some implementations, the position tracking circuit may monitor a current transmission coordinate of the beam scanner 102 and generate transmission coordinate information based on the current transmission coordinate. For example, the system controller 106 may monitor the current transmission coordinate based on the rotational position information received from the driver 118. Alternatively, the system controller 106 may monitor the current transmission coordinate based on a scanning program used to control the beam scanner 102.

Additionally, the system controller 106 may use the rotational position information to trigger light beams at the light transmitter 108 or measurements at the one or more acquisition elements. For example, the system controller 106 may use the rotational position information to set a transmission time of light transmitter 108 in order to target a particular 2D measurement coordinate of the 2D scanning pattern.

In some implementations, the system controller 106 may use the rotational position information to trigger the one or more acquisition elements to acquire measurements at regular angular intervals of the beam scanner 102. For example, during the angular acquisition scheme, the one or more acquisition elements may be configured to acquire the measurements at regular angular intervals of the beam scanner 102. The system controller 106 may monitor a rotational position of the beam scanner 102 based on the rotational position information, and trigger the measurements at one or more acquisition angles defined in one or more acquisition instructions. The measurements may be triggered at a regular angular interval defined by an acquisition control parameter, at acquisition angles (regular or irregular) defined by a mathematical formula, at acquisition angles defined by an acquisition pattern (regular or irregular), and/or at one or more specific acquisition angles. In some implementations, each acquisition instruction may specify one specific angle or a set of specific angles at which measurement acquisitions are to be taken.

In some implementations, the system controller 106 is configured to set a driving frequency of the beam scanner 102 for each scanning axis and is capable of synchronizing the oscillations about the first scanning axis 112 and the second scanning axis 114. In particular, the system controller 106 may be configured to control an actuation of the beam scanner 102 about each scanning axis by controlling the driving signals. The system controller 106 may control the frequency, the phase, the duty cycle, and/or a voltage level of the driving signals to control the actuations about the first scanning axis 112 and the second scanning axis 114. The actuation of the beam scanner 102 about a particular scanning axis controls its range of motion and scanning rate about that particular scanning axis.

In some implementations, the system controller 106 may include one or more processors 116 configured to receive the rotational position information, process the rotational position information, and generate one or more control signals for controlling components of the 2D scanning system 100. Additionally, the one or more processors 116 may be configured to receive measurements acquired by the one or more acquisition elements, calculate distances to an object (e.g., the target object) from which a reflected light beam is reflected, and generate object data or an image based on the distances. In some implementations, the one or more processors 116 may include a signal processor, such as application-specific integrated circuit (ASIC) or a field-programmable gate array (FPGA), that is configured to process the measurements acquired by the one or more acquisition elements. Thus, the system controller 106 may include both processing and control circuity that is configured to generate control signals for controlling the components of the 2D scanning system 100.

In some implementations, the object data may be used during a manufacturing process of an object (e.g., a vehicle) to detect whether a part is assembled correctly and/or satisfies one or more specifications. Thus, the object data may be used to detect manufacturing faults that may occur during the manufacturing process.

As indicated above, FIG. 1 is provided as an example. Other examples may differ from what is described with regard to FIG. 1. In practice, the 2D scanning system 100 may include additional components, fewer components, different components, or differently arranged components than those shown in FIG. 1 without deviating from the disclosure provided above. In addition, in some implementations, the 2D scanning system 100 may include one or more additional mirrors to scan the field-of-view.

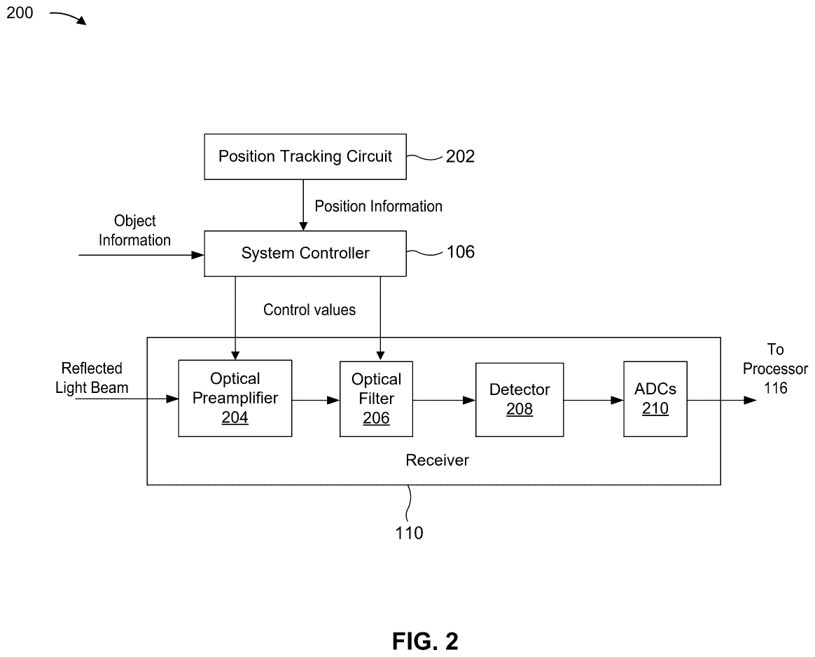

FIG. 2 shows a system 200 according to one or more implementations. The system 200 may be part of the 2D scanning system 100 described above in connection with FIG. 1. The system 200 includes the system controller 106 and the receiver 110. In some implementations, the system 200 may include a position tracking circuit 202. The position tracking circuit 202 may include the driver 118, as described above in connection with FIG. 1.

The receiver 110 may include an optical preamplifier 204, an optical filter 206, a detector 208, and one or more acquisition elements 210. The detector 208 may include one or more sensor elements (e.g., one or more photodetectors) that convert light into electric signals. In some implementations, the detector 208 may be a photodetector array. The one or more acquisition elements 210 may be ADCs, as described above in connection with FIG. 1.

The receiver 110 may receive a reflected light beam that corresponds to a light beam transmitted by a light transmitter (e.g., light transmitter 108). The optical preamplifier 204 may apply an optical gain to the reflected light beam to produce a gain-compensated light beam. The optical preamplifier 204 may apply the optical gain to the reflected light beam such that the gain-compensated light beam is within a dynamic range of the detector 208 (e.g., within a dynamic range of the one or more sensor elements of the detector 208). The optical preamplifier 204 may apply the optical gain to increase an SNR of the reflected light beam prior to being received by the detector 208. Thus, the optical preamplifier 204 is arranged in a receiver path of the receiver 110, upstream from the detector 208. Thus, the detector 208 may receive the gain-compensated light beam from the optical preamplifier 204 and acquire measurements of the gain-compensated light beam.

In some implementations, the receiver 110 includes the optical filter 206, which is arranged between the optical preamplifier 204 and the detector 208. The optical filter 206 may receive the gain-compensated light beam from the optical preamplifier 204, and filter out broadband noise produced by the optical preamplifier 204. In some implementations, the optical filter 206 is a narrow band pass filter having a passband that includes a wavelength of the light transmitter. Thus, the optical filter 206 may allow wavelengths of the light transmitter to pass to the detector 208, and reject other wavelengths, such as broadband noise, that are outside of the passband. In some implementations, the light transmitter has a tunable wavelength, and the optical filter is a tunable optical filter with a tunable passband that is configured to be tuned based on the tunable wavelength. For example, the system controller 106 may control the tunable wavelength of the light transmitter and may also control the tunable passband of the optical filter 206 based on a wavelength selected by the system controller 106 for use as the tunable wavelength. Accordingly, the system controller 106 may provide a control signal to the optical filter 206 to adjust the tunable passband to ensure the tunable passband is aligned with the wavelength being emitted by the light transmitter. The control signal may include control values for controlling the tunable passband.

In some implementations, the optical gain of the optical preamplifier 204 is a dynamic optical gain. The optical preamplifier 204 may receive a control signal from the system controller 106 that controls the optical gain on a dynamic basis. The control signal may include control values for controlling the optical gain. For example, in some implementations, the optical preamplifier 204 may adjust the optical gain on a dynamic basis based on the 2D scanning pattern. In this example, the optical preamplifier 204 may adjust the optical gain to different optical gain values based on a position of the beam scanner 102 within the 2D scanning pattern. Thus, the optical preamplifier 204 may adjust the optical gain to different optical gain values based on rotational position information detected by the driver 118. Alternatively, the optical preamplifier 204 may adjust the optical gain to different optical gain values as the system control 106 executes a scanning plan that drives the 2D scanning pattern. Put another way, the system controller 106 may have information that indicates a position of the beam scanner 102 within the 2D scanning pattern, and the system controller 106 may generate control signals on a dynamic basis for adjusting the optical gain as the position of the beam scanner 102 changes within 2D scanning pattern. The system controller 106 may dynamically control the optical gain in order to maintain the gain-compensated light beam within the dynamic range of the detector 208.

Additionally, or alternatively, the optical preamplifier 204 may adjust the optical gain on a dynamic basis based on a power map of a target object. For example, the optical preamplifier 204 may adjust the optical gain according to one or more characteristics of the target object in order to maintain the gain-compensated light beam within the dynamic range of the detector 208. The power map may represent a percentage of light or a return power the target object is expected to return back to the receiver 110. The power map may be mapped across a surface area of the target object such that each point within the power map corresponds to a different point on the surface area. The return power that a point of target object is expected to return back to the receiver 110 may be based on one or more characteristics of the target object at that point. For example, one or more characteristics may include reflectivity and/or surface angle.

The optical preamplifier 204 may adjust the optical gain on a dynamic basis such that the optical gain is increased for surface regions corresponding to low return power, and such that the optical gain is decreased for surface regions corresponding to high return power. In some cases, the optical gain may be decreased to attenuate the reflected light beam. The system controller 106 may receive the power map as object information, and determine optical gain values for the optical gain based on the object information, and provide the optical gain values to the optical preamplifier 204 on a dynamic basis to adjust the optical gain. Thus, the system controller 106 may dynamically control the optical gain in order to maintain the gain-compensated light beam within the dynamic range of the detector 208.

In some implementations, the system controller 106 may adjust the optical gain values provided to the optical preamplifier 204 based on a combination of the object information and the 2D scanning pattern. For example, the system controller 106 may correlate the object information with the 2D scanning pattern to determine optical gain values for each point within the 2D scanning pattern, and may adjust the optical gain values provided to optical preamplifier 204 based on a position of the beam scanner 102 within 2D scanning pattern. Thus, the system controller 106 may dynamically control the optical gain in order to maintain the gain-compensated light beam within the dynamic range of the detector 208.

In some implementations, the position tracking circuit 202 may monitor a transmission direction of the beam scanner 102 within the 2D scanning pattern and generate transmission direction information based on the transmission direction. The transmission direction may be determined based on the rotational position information detected by the driver 118. The system controller 106 may adjust the optical gain on a dynamic basis based on the transmission direction information such that the optical gain changes as the transmission direction changes.

In some implementations, the position tracking circuit 202 may monitor a current transmission coordinate of the beam scanner 102 and generate transmission coordinate information based on the current transmission coordinate. The current transmission coordinate may be a 2D coordinate within the field-of-view or scanning plane at which a light beam is transmitted. The current transmission coordinate may be based on a detected position or an expected position of the beam scanner 102. Additionally, the system controller 106 may receive a simulation of the target object as object information. The simulation of the target object may be a virtual representation of the target object, such as a computer-aided design (CAD). The system controller 106 may generate a power map of the target object based on the simulation. Here, each point of a plurality of points within the power map may be mapped to a respective transmission coordinate of a plurality of transmission coordinates.

Additionally, the system controller 106 may calculate a set of optical gain values, including a respective optical gain value for each point of the plurality of points within the power map. Each respective optical gain value may be associated with a respective transmission coordinate of the plurality of transmission coordinates. The system controller 106 may adjust, based on the transmission coordinate information, the optical gain on a dynamic basis by setting the optical gain to an optical gain value, from the set of optical gain values, that is associated with the current transmission coordinate indicated by the transmission coordinate information. In some implementations, the system controller 106 may to calculate, based on the dynamic range of the detector 208, the respective optical gain value for each point within the power map such that each optical gain value is configured to ensure all light received by the detector 208 is the dynamic range of the detector 208. In some implementations, the respective optical gain values may be scaled according to the dynamic range of the detector 208. In some implementations, the optical preamplifier 204 is configured to apply the optical gain to amplify or to attenuate the reflected light beam in order to maintain the gain-compensated light beam within the dynamic range. The system controller 106 may adjust the optical gain in real-time during a scan of the target object, for example, based on position information (e.g., scanner position information) provided by the position tracking circuit 202.

In some implementations, the position tracking circuit 202 may monitor a current transmission coordinate of the beam scanner 102 and generate transmission coordinate information based on the current transmission coordinate. The system controller 106 may use the light transmitter 108, the beam scanner 102, and the receiver 110 perform an initial scan of the target object to obtain a power map of the target object. Thus, instead of using a simulation of the target object to obtain the power map, the system controller 106 may perform the initial scan of the target object to obtain the power map. During the initial scan, an entire surface area of the target object may be scanned by one or more light beams, and measurements obtained by the detector 208 may be used to generate the power map. Each point of a plurality of points within the power map may be mapped to a respective transmission coordinate of a plurality of transmission coordinates.

Additionally, the system controller 106 may calculate a set of optical gain values, including a respective optical gain value for each point of the plurality of points within the power map. Each respective optical gain value may be associated with a respective transmission coordinate of the plurality of transmission coordinates. The system controller 106 may adjust, based on the transmission coordinate information, the optical gain on a dynamic basis by setting the optical gain to an optical gain value, from the set of optical gain values, that is associated with the current transmission coordinate indicated by the transmission coordinate information. In some implementations, the system controller 106 may to calculate, based on the dynamic range of the detector 208, the respective optical gain value for each point within the power map such that each optical gain value is configured to ensure all light received by the detector 208 is the dynamic range of the detector 208. In some implementations, the optical preamplifier 204 is configured to apply the optical gain to amplify or to attenuate the reflected light beam in order to maintain the gain-compensated light beam within the dynamic range. The system controller 106 may adjust the optical gain in real-time during a scan of the target object, for example, based on position information provided by the position tracking circuit 202.

In some implementations, the position tracking circuit 202 may monitor a current transmission coordinate of the beam scanner 102 and generate transmission coordinate information based on the current transmission coordinate. The system controller 106 may receive a simulation of the target object, and generate a power map of the target object based on the simulation. Additionally, the system controller 106 may identify sub-regions of the target object based on the power map. The system controller 106 may calculate, based on the power map, a set of optical gain values, including a respective optical gain value for each sub-region. The system controller 106 may adjust, based on the transmission coordinate information, the optical gain on a dynamic basis by setting the optical gain to an optical gain value, from the set of optical gain values, that is associated with a sub-region that corresponds to the current transmission coordinate indicated by the transmission coordinate information. Adjusting the optical gain value on a sub-region basis, instead of a point-by-point basis, may enable dynamic optical gain adjustment to be used in systems with slower response times for maintaining the gain-compensated light beam within the dynamic range. The system controller 106 may adjust the optical gain in real-time during a scan of the target object, for example, based on position information provided by the position tracking circuit 202.

In some implementations, the position tracking circuit 202 may monitor a current transmission coordinate of the beam scanner 102 and generate transmission coordinate information based on the current transmission coordinate. The system controller 106 may perform an initial scan of a target object to obtain a power map of the target object. The system controller 106 may identify, based on the power map, sub-regions of the target object. The system controller 106 may calculate, based on the power map, a set of optical gain values, including a respective optical gain value for each sub-region. The system controller 106 may adjust, based on the transmission coordinate information, the optical gain on a dynamic basis by setting the optical gain to an optical gain value, from the set of optical gain values, that is associated with a sub-region that corresponds to the current transmission coordinate indicated by the transmission coordinate information. In some implementations, the optical preamplifier 204 is configured to apply the optical gain to amplify or to attenuate the reflected light beam in order to maintain the gain-compensated light beam within the dynamic range. The system controller 106 may adjust the optical gain in real-time during a scan of the target object, for example, based on position information provided by the position tracking circuit 202.

In some implementations, the light beam is a continuous-wave light beam. As a result, the reflected light beam is also a continuous-wave light beam. The system controller 106 may calibrate the optical gain in a real-time, dynamic manner based on using a preliminary optical signal or a preliminary portion of an optical signal (e.g., preliminary portion of a continuous-wave light beam or a first segment of the continuous-wave light beam). For example, the transmitter 108 may transmit the preliminary optical signal or a preliminary portion of the optical signal. The detector 208 may acquire an initial measurement of a gain-compensated light beam corresponding to the preliminary optical signal or the preliminary portion of the optical signal, and provide the initial measurement to the system controller 106. The system controller 106 may, based on the initial measurement, adjust the optical gain of the optical preamplifier 204 to an adjusted optical gain value such that a subsequent measurement of a gain-compensated light beam is within the dynamic range of the one or more sensor elements. The detector 208 may acquire a second measurement of a gain-compensated light beam that corresponds to the adjusted optical gain value, the second measurement corresponding to a second optical signal or a secondary portion of an optical signal (e.g., a second segment of the continuous-wave light beam). The system controller 106 may use the second measurement to derive object data of a target object. In this way, the optical gain of the optical preamplifier 204 is calibrated prior to obtaining the second measurement.

In some implementations, the system controller 106 is configured to adjust the optical gain on a dynamic basis. The transmitter 108 may transmit a preliminary light beam prior to transmitting the light beam. The detector 208 may acquire an initial measurement of a preliminary reflected light beam corresponding to the preliminary light beam. The initial measurement may be acquired with or without a gain being applied by the optical preamplifier 204. The system controller 106 may, based on the initial measurement, adjust the optical gain to an adjusted optical gain value such that a gain-compensated light beam (e.g., a gain-compensated light beam of a subsequent light beam) is within the dynamic range of the detector 208. The detector 208 may acquire a measurement of the gain-compensated light beam that corresponds to the adjusted optical gain value for use in generating object data. Thus, the optical gain of the optical preamplifier 204 is calibrated prior to obtaining measurement(s) used for object data.

In some implementations, the system controller 106 is configured to adjust the optical gain on a dynamic basis. The transmitter 108 may transmit the light beam as a continuous-wave light beam. The detector 208 may acquire an initial measurement of the reflected light beam corresponding to a first segment of the continuous-wave light beam. The initial measurement may be acquired with or without a gain being applied by the optical preamplifier 204. The system controller 106 is configured to, based on the initial measurement, adjust the optical gain to an adjusted optical gain value such that a gain-compensated light beam is within the dynamic range of the detector 208. The detector 208 may acquire a measurement of the gain-compensated light beam that corresponds to the adjusted optical gain value for use in generating object data. The measurement of the gain-compensated light beam may correspond to a second segment of the continuous-wave light beam. Thus, the optical gain of the optical preamplifier 204 is calibrated prior to obtaining measurement(s) used for object data.

As indicated above, FIG. 2 is provided as an example. Other examples may differ from what is described with regard to FIG. 2.

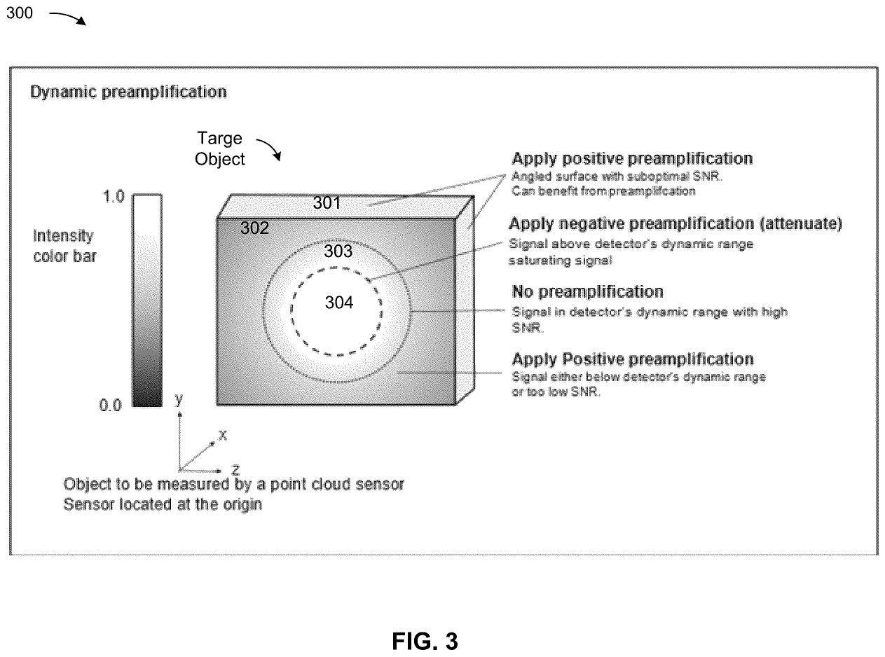

FIG. 3 shows a power map 300 of a target object. The target object may have edge regions 301 with angled surfaces with suboptimal SNR. Thus, when the edge regions 301 are being scanned, the optical preamplifier 204 may apply an optical gain to boost or amplify the reflected light signal such that the gain-compensated light beam is within the dynamic range of the detector 208. Additionally, the target object may have peripheral regions 302 that may either reflect signals to be below the dynamic range of the detector 208 or have too low of an SNR. Thus, when the peripheral regions 302 are being scanned, the optical preamplifier 204 may apply an optical gain to boost or amplify the reflected light signal such that the gain-compensated light beam is within the dynamic range of the detector 208 and/or have improved SNR.

Additionally, the target object may have inner regions 303 that may reflect signals that are within the dynamic range of the detector 208 and have high SNR. Thus, when the inner regions 303 are being scanned, the optical preamplifier 204 may apply zero optical gain to the reflected light signal, since the reflected light signal is expected to be within the dynamic range of the detector 208 and have sufficient SNR.

Additionally, the target object may have inner-most regions 304 that may reflect signals that are above the dynamic range of the detector 208, leading to saturation. Thus, when the inner-most regions 304 are being scanned, the optical preamplifier 204 may apply a negative optical gain to attenuate the reflected light signal such that the gain-compensated light beam is within the dynamic range of the detector 208.

The system controller 106 may adjust the optical gain on a point-by-point basis (e.g., each transmission coordinate is assigned optical gain value on an individual basis), or on a sub-region-by-sub-region basis (e.g., each transmission coordinate is assigned optical gain value on a sub-group basis).

As indicated above, FIG. 3 is provided as an example. Other examples may differ from what is described with regard to FIG. 3.

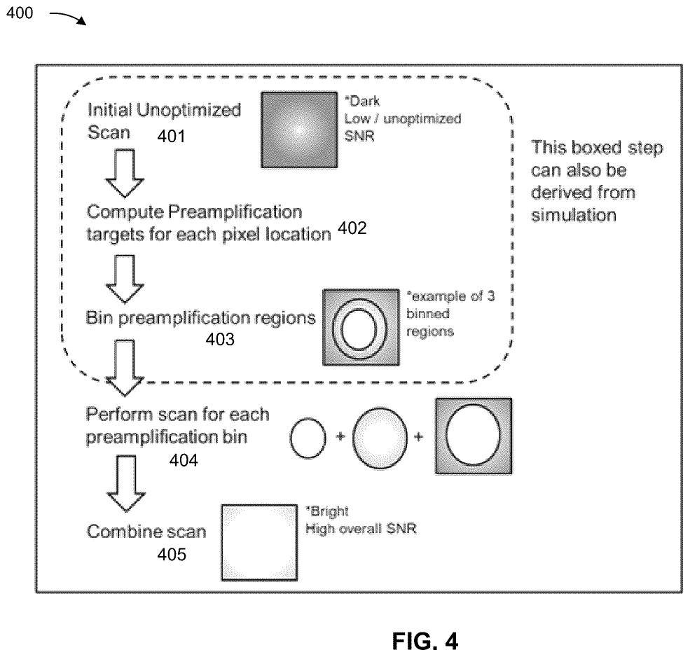

FIG. 4 shows a diagram illustrating a method 400 of scanning a target object using optical preamplification. The method 400 may include performing an initial unoptimized scan of a target object to obtain a power map of the target object based on returned power values (process 401). In some implementations, the power map may be obtained from a simulation of the target object instead of using the initial unoptimized scan to obtain returned power values used for computing/constructing the power map. The method 400 may further include computing preamplification targets for each pixel location of the initial unoptimized scan (process 402). The preamplification targets may be a set of optical gain values, including a respective optical gain value for each point of the plurality of points within the power map. Each respective optical gain value may be associated with a respective transmission coordinate of the plurality of transmission coordinates. In other words, each respective optical gain value may be associated with a respective pixel location within a scanning pattern. The preamplification targets may be computed to ensure that each light beam that reaches a detector is within a dynamic range of the detector. The method 400 may further include binning preamplification regions (e.g., preamplification bins) based on the computed preamplification targets (process 403). The method 400 may further include performing a scan for each preamplification bin (process 404). In the example shown in FIG. 4, three preamplification bins are determined. As a result, three scans are performed. The method 400 may further include combining the scans (process 405).

As indicated above, FIG. 4 is provided as an example. Other examples may differ from what is described with regard to FIG. 4.

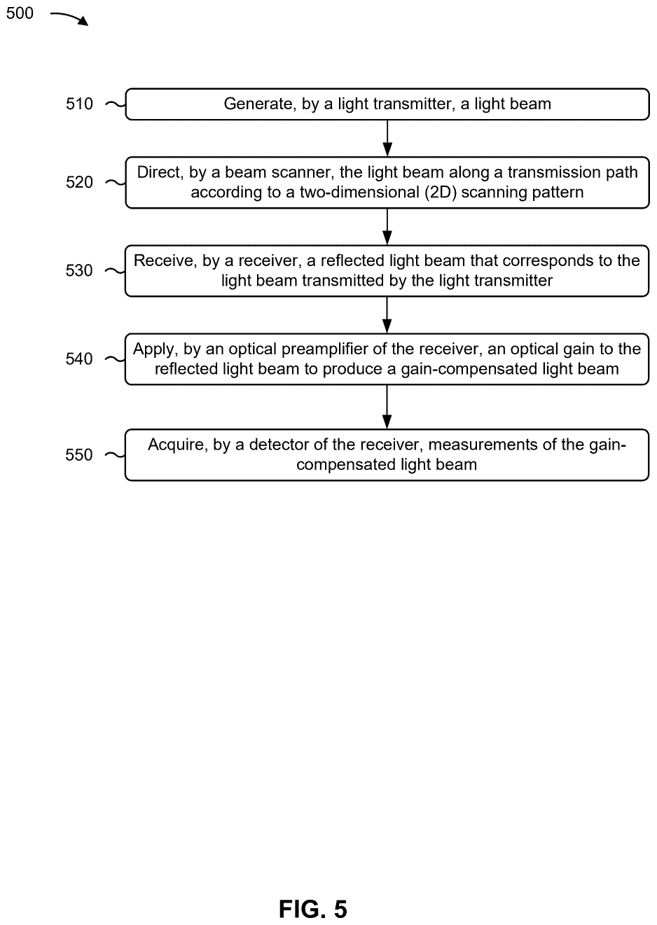

FIG. 5 is a flowchart of an example process 500 associated with improving signal-to-noise ratio in light detection and ranging by optical preamplification. One or more process blocks of FIG. 5 are performed by a receiver (e.g., receiver 110) and/or by another device or a group of devices separate from or including the receiver, such as 2D scanning system 100 and/or system 200. Additionally, or alternatively, one or more process blocks of FIG. 5 may be performed by one or more components of system 200, such as system controller 106, position tracking circuit 202, optical preamplifier 204, optical filter 206, detector 208, and/or acquisition elements 210.

As shown in FIG. 5, process 500 includes generating a light beam (block 510). For example, the light transmitter 108 may generate a light beam, as described above.

As further shown in FIG. 5, process 500 includes directing the light beam along a transmission path according to a 2D scanning pattern (block 520). For example, the beam scanner 102 may direct the light beam along the transmission path according to the 2D scanning pattern, as described above.

As further shown in FIG. 5, process 500 includes receiving a reflected light beam that corresponds to the light beam transmitted by the light transmitter (block 530). For example, the receiver 110 may receive the reflected light beam, as described above.

As further shown in FIG. 5, process 500 includes applying an optical gain to the reflected light beam to produce a gain-compensated light beam (block 540). For example, the optical preamplifier may apply the optical gain to the reflected light beam to produce the gain-compensated light beam, as described above.

As further shown in FIG. 5, process 500 includes acquiring measurements of the gain-compensated light beam (block 550). The detector 208 may acquire measurements of the gain-compensated light beam, as described above. Applying the optical gain in block 540 may include applying the optical gain to the reflected light beam such that the gain-compensated light beam is within a dynamic range of the detector, as described above.

Process 500 may include additional aspects, such as any single aspect or any combination of aspects described below and/or in connection with one or more other processes described elsewhere herein.

In a first aspect, process 500 includes filtering, by a narrow band pass filter arranged between the optical preamplifier and the detector, out broadband noise from the gain-compensated light beam, the broadband noise being produced by the optical preamplifier.

In a second aspect, applying the optical gain to the reflected light beam includes adjusting the optical gain on a dynamic basis based on a power map of a target object.

In a third aspect, process 500 includes monitoring a current transmission direction of the beam scanner, wherein applying the optical gain to the reflected light beam includes adjusting the optical gain on a dynamic basis based on the current transmission direction and based on a power map of a target object.

In a fourth aspect, process 500 includes transmitting, by the light transmitter, a preliminary light beam or a preliminary portion of the light beam; obtaining, by the detector, an initial measurement of a reflection of the preliminary light beam or the preliminary portion of the light beam; and adjusting, by a controller, the optical gain of the optical preamplifier based on the initial measurement such that the gain-compensated light beam is within the dynamic range of the detector.

Although FIG. 5 shows example blocks of process 500, in some implementations, process 500 includes additional blocks, fewer blocks, different blocks, or differently arranged blocks than those depicted in FIG. 5. Additionally, or alternatively, two or more of the blocks of process 500 may be performed in parallel.

The following provides an overview of some Aspects of the present disclosure:

Aspect 1: A beam scanning system, comprising: a light transmitter configured to transmit a light beam; a beam scanner configured to receive the light beam from the light transmitter and direct the light beam along a transmission path according to a two-dimensional (2D) scanning pattern; and a receiver configured to receive a reflected light beam that corresponds to the light beam transmitted by the light transmitter, the receiver comprising: an optical preamplifier configured to apply an optical gain to the reflected light beam to produce a gain-compensated light beam; and a detector comprising one or more sensor elements configured to acquire measurements of the gain-compensated light beam, wherein the optical preamplifier is configured to apply the optical gain to the reflected light beam such that the gain-compensated light beam is within a dynamic range of the one or more sensor elements.

Aspect 2: The beam scanning system of Aspect 1, wherein the optical preamplifier is configured to increase a signal-to-noise ratio (SNR) of the reflected light beam.

Aspect 3: The beam scanning system of any of Aspects 1-2, wherein the one or more sensor elements are photodetectors.

Aspect 4: The beam scanning system of any of Aspects 1-3, wherein the receiver further comprises: an optical filter arranged between the optical preamplifier and the detector, wherein the optical filter is configured to receive the gain-compensated light beam and filter out broadband noise produced by the optical preamplifier.

Aspect 5: The beam scanning system of Aspect 4, wherein the optical filter is a narrow band pass filter having a passband that includes a wavelength of the light transmitter.

Aspect 6: The beam scanning system of Aspect 5, wherein the light transmitter has a tunable wavelength, and wherein the optical filter is a tunable optical filter with a tunable passband that is configured to be tuned based on the tunable wavelength.

Aspect 7: The beam scanning system of any of Aspects 1-6, wherein the optical gain is a dynamic optical gain, and wherein the optical preamplifier is configured to adjust the optical gain on a dynamic basis based on the 2D scanning pattern.

Aspect 8: The beam scanning system of any of Aspects 1-7, wherein the optical gain is a dynamic optical gain, and wherein the optical preamplifier is configured to adjust the optical gain on a dynamic basis based on a power map of a target object.

Aspect 9: The beam scanning system of any of Aspects 1-8, further comprising: a position tracking circuit configured to monitor a transmission direction of the beam scanner within the 2D scanning pattern and generate transmission direction information based on the transmission direction; and a controller configured to adjust the optical gain on a dynamic basis based on the transmission direction information such that the optical gain changes as the transmission direction changes.

Aspect 10: The beam scanning system of any of Aspects 1-9, further comprising: a position tracking circuit configured to monitor a current transmission coordinate of the beam scanner and generate transmission coordinate information based on the current transmission coordinate; and a controller configured to: receive a simulation of a target object, generate a power map of the target object based on the simulation, wherein each point of a plurality of points within the power map is mapped to a respective transmission coordinate of a plurality of transmission coordinates, calculate a set of optical gain values, including a respective optical gain value for each point of the plurality of points within the power map, wherein each respective optical gain value is associated with a respective transmission coordinate of the plurality of transmission coordinates, and adjust, based on the transmission coordinate information, the optical gain on a dynamic basis by setting the optical gain to an optical gain value, from the set of optical gain values, that is associated with the current transmission coordinate indicated by the transmission coordinate information.

Aspect 11: The beam scanning system of Aspect 10, wherein the controller is configured to calculate, based on a dynamic range of the detector, the respective optical gain value for each point within the power map.

Aspect 12: The beam scanning system of Aspect 10, wherein the optical preamplifier is configured to apply the optical gain to amplify or to attenuate the reflected light beam in order to maintain the gain-compensated light beam within the dynamic range.

Aspect 13: The beam scanning system of any of Aspects 1-12, further comprising: a position tracking circuit configured to monitor a current transmission coordinate of the beam scanner and generate transmission coordinate information based on the current transmission coordinate; and a controller configured to: perform an initial scan of a target object to obtain a power map of the target object, wherein each point of a plurality of points within the power map is mapped to a respective transmission coordinate of a plurality of transmission coordinates, calculate a set of optical gain values, including a respective optical gain value for each point of the plurality of points within the power map, wherein each respective optical gain value is associated with a respective transmission coordinate of the plurality of transmission coordinates, and adjust, based on the transmission coordinate information, the optical gain on a dynamic basis by setting the optical gain to an optical gain value, from the set of optical gain values, that is associated with the current transmission coordinate indicated by the transmission coordinate information.

Aspect 14: The beam scanning system of Aspect 13, wherein the controller is configured to adjust the optical gain in real-time during a scan of the target object.

Aspect 15: The beam scanning system of any of Aspects 1-14, further comprising: a position tracking circuit configured to monitor a current transmission coordinate of the beam scanner and generate transmission coordinate information based on the current transmission coordinate; and a controller configured to: receive a simulation of a target object, generate a power map of the target object based on the simulation, identify sub-regions of the target object based on the power map, calculate, based on the power map, a set of optical gain values, including a respective optical gain value for each sub-region, and adjust, based on the transmission coordinate information, the optical gain on a dynamic basis by setting the optical gain to an optical gain value, from the set of optical gain values, that is associated with a sub-region that corresponds to the current transmission coordinate indicated by the transmission coordinate information.

Aspect 16: The beam scanning system of any of Aspects 1-15, further comprising: a position tracking circuit configured to monitor a current transmission coordinate of the beam scanner and generate transmission coordinate information based on the current transmission coordinate; and a controller configured to: perform an initial scan of a target object to obtain a power map of the target object, identify, based on the power map, sub-regions of the target object, calculate, based on the power map, a set of optical gain values, including a respective optical gain value for each sub-region, and adjust, based on the transmission coordinate information, the optical gain on a dynamic basis by setting the optical gain to an optical gain value, from the set of optical gain values, that is associated with a sub-region that corresponds to the current transmission coordinate indicated by the transmission coordinate information.

Aspect 17: The beam scanning system of any of Aspects 1-16, further comprising: a controller configured to adjust the optical gain on a dynamic basis, wherein the transmitter is configured to transmit a preliminary light beam prior to transmitting the light beam, wherein the detector is configured to acquire an initial measurement of a preliminary reflected light beam corresponding to the preliminary light beam, and wherein the controller is configured to, based on the initial measurement, adjust the optical gain to an adjusted optical gain value such that the gain-compensated light beam is within the dynamic range of the one or more sensor elements.

Aspect 18: The beam scanning system of any of Aspects 1-17, further comprising: a controller configured to adjust the optical gain on a dynamic basis, wherein the light beam is a continuous-wave light beam, wherein the detector is configured to acquire an initial measurement of the reflected light beam corresponding to a first segment of the continuous-wave light beam, wherein the controller is configured to, based on the initial measurement, adjust the optical gain to an adjusted optical gain value such that the gain-compensated light beam is within the dynamic range of the one or more sensor elements, and wherein the detector is configured to acquire a measurement of the gain-compensated light beam that corresponds to the adjusted optical gain value, the measurement corresponding to a second segment of the continuous-wave light beam.

Aspect 19: A method of beam scanning, comprising: transmitting, by a light transmitter, a light beam; directing, by a beam scanner, the light beam along a transmission path according to a two-dimensional (2D) scanning pattern; receiving, by a receiver, a reflected light beam that corresponds to the light beam transmitted by the light transmitter; applying, by an optical preamplifier of the receiver, an optical gain to the reflected light beam to produce a gain-compensated light beam; and acquiring, by a detector of the receiver, measurements of the gain-compensated light beam, wherein applying the optical gain includes applying the optical gain to the reflected light beam such that the gain-compensated light beam is within a dynamic range of the detector.

Aspect 20: The method of Aspect 19, further comprising: filtering, by a narrow band pass filter arranged between the optical preamplifier and the detector, out broadband noise from the gain-compensated light beam, the broadband noise being produced by the optical preamplifier.

Aspect 21: The method of any of Aspects 19-20, wherein applying the optical gain to the reflected light beam includes adjusting the optical gain on a dynamic basis based on a power map of a target object.

Aspect 22: The method of any of Aspects 19-21, further comprising: monitoring a current transmission direction of the beam scanner, wherein applying the optical gain to the reflected light beam includes adjusting the optical gain on a dynamic basis based on the current transmission direction and based on a power map of a target object.

Aspect 23: The method of any of Aspects 19-22, further comprising: transmitting, by the light transmitter, a preliminary light beam or a preliminary portion of the light beam; obtaining, by the detector, an initial measurement of a reflection of the preliminary light beam or the preliminary portion of the light beam; and adjusting, by a controller, the optical gain of the optical preamplifier based on the initial measurement such that the gain-compensated light beam is within the dynamic range of the detector.

Aspect 24: A system configured to perform one or more operations recited in one or more of Aspects 1-23.

Aspect 25: An apparatus comprising means for performing one or more operations recited in one or more of Aspects 1-23.

Aspect 26: A non-transitory computer-readable medium storing a set of instructions, the set of instructions comprising one or more instructions that, when executed by a device, cause the device to perform one or more operations recited in one or more of Aspects 1-23.

Aspect 27: A computer program product comprising instructions or code for executing one or more operations recited in one or more of Aspects 1-23.

The foregoing disclosure provides illustration and description, but is not intended to be exhaustive or to limit the implementations to the precise forms disclosed. Modifications and variations may be made in light of the above disclosure or may be acquired from practice of the implementations. Furthermore, any of the implementations described herein may be combined unless the foregoing disclosure expressly provides a reason that one or more implementations may not be combined.

As used herein, the term “component” is intended to be broadly construed as hardware, firmware, and/or a combination of hardware and software. It will be apparent that systems and/or methods described herein may be implemented in different forms of hardware, firmware, or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be designed to implement the systems and/or methods based on the description herein.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When a component or one or more components (e.g., a laser emitter or one or more laser emitters) is described or claimed (within a single claim or across multiple claims) as performing multiple operations or being configured to perform multiple operations, this language is intended to broadly cover a variety of architectures and environments. For example, unless explicitly claimed otherwise (e.g., via the use of “first component” and “second component” or other language that differentiates components in the claims), this language is intended to cover a single component performing or being configured to perform all of the operations, a group of components collectively performing or being configured to perform all of the operations, a first component performing or being configured to perform a first operation and a second component performing or being configured to perform a second operation, or any combination of components performing or being configured to perform the operations. For example, when a claim has the form “one or more components configured to: perform X; perform Y; and perform Z,” that claim should be interpreted to mean “one or more components configured to perform X; one or more (possibly different) components configured to perform Y; and one or more (also possibly different) components configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A beam scanning system, comprising:
a light transmitter configured to transmit a light beam;
a beam scanner configured to receive the light beam from the light transmitter and direct the light beam along a transmission path according to a two-dimensional (2D) scanning pattern; and
a receiver configured to receive a reflected light beam that corresponds to the light beam transmitted by the light transmitter, the receiver comprising:
an optical preamplifier configured to apply an optical gain to the reflected light beam to produce a gain-compensated light beam; and
a detector comprising one or more sensor elements configured to acquire measurements of the gain-compensated light beam,
wherein the optical preamplifier is configured to apply the optical gain to the reflected light beam such that the gain-compensated light beam is within a dynamic range of the one or more sensor elements.

2. The beam scanning system of claim 1, wherein the optical preamplifier is configured to increase a signal-to-noise ratio (SNR) of the reflected light beam.

3. The beam scanning system of claim 1, wherein the one or more sensor elements are photodetectors.

4. The beam scanning system of claim 1, wherein the receiver further comprises:
an optical filter arranged between the optical preamplifier and the detector, wherein the optical filter is configured to receive the gain-compensated light beam and filter out broadband noise produced by the optical preamplifier.

5. The beam scanning system of claim 4, wherein the optical filter is a narrow band pass filter having a passband that includes a wavelength of the light transmitter.

6. The beam scanning system of claim 5, wherein the light transmitter has a tunable wavelength, and
wherein the optical filter is a tunable optical filter with a tunable passband that is configured to be tuned based on the tunable wavelength.

7. The beam scanning system of claim 1, wherein the optical gain is a dynamic optical gain, and
wherein the optical preamplifier is configured to adjust the optical gain on a dynamic basis based on the 2D scanning pattern.

8. The beam scanning system of claim 1, wherein the optical gain is a dynamic optical gain, and
wherein the optical preamplifier is configured to adjust the optical gain on a dynamic basis based on a power map of a target object.

9. The beam scanning system of claim 1, further comprising:
a position tracking circuit configured to monitor a transmission direction of the beam scanner within the 2D scanning pattern and generate transmission direction information based on the transmission direction; and
a controller configured to adjust the optical gain on a dynamic basis based on the transmission direction information such that the optical gain changes as the transmission direction changes.

10. The beam scanning system of claim 1, further comprising:
a position tracking circuit configured to monitor a current transmission coordinate of the beam scanner and generate transmission coordinate information based on the current transmission coordinate; and
a controller configured to:
receive a simulation of a target object,
generate a power map of the target object based on the simulation, wherein each point of a plurality of points within the power map is mapped to a respective transmission coordinate of a plurality of transmission coordinates,
calculate a set of optical gain values, including a respective optical gain value for each point of the plurality of points within the power map, wherein each respective optical gain value is associated with a respective transmission coordinate of the plurality of transmission coordinates, and
adjust, based on the transmission coordinate information, the optical gain on a dynamic basis by setting the optical gain to an optical gain value, from the set of optical gain values, that is associated with the current transmission coordinate indicated by the transmission coordinate information.

11. The beam scanning system of claim 10, wherein the controller is configured to calculate, based on a dynamic range of the detector, the respective optical gain value for each point within the power map.

12. The beam scanning system of claim 10, wherein the optical preamplifier is configured to apply the optical gain to amplify or to attenuate the reflected light beam in order to maintain the gain-compensated light beam within the dynamic range.

13. The beam scanning system of claim 1, further comprising:
a position tracking circuit configured to monitor a current transmission coordinate of the beam scanner and generate transmission coordinate information based on the current transmission coordinate; and
a controller configured to:
perform an initial scan of a target object to obtain a power map of the target object, wherein each point of a plurality of points within the power map is mapped to a respective transmission coordinate of a plurality of transmission coordinates,
calculate a set of optical gain values, including a respective optical gain value for each point of the plurality of points within the power map, wherein each respective optical gain value is associated with a respective transmission coordinate of the plurality of transmission coordinates, and
adjust, based on the transmission coordinate information, the optical gain on a dynamic basis by setting the optical gain to an optical gain value, from the set of optical gain values, that is associated with the current transmission coordinate indicated by the transmission coordinate information.

14. The beam scanning system of claim 13, wherein the controller is configured to adjust the optical gain in real-time during a scan of the target object.

15. The beam scanning system of claim 1, further comprising:
a position tracking circuit configured to monitor a current transmission coordinate of the beam scanner and generate transmission coordinate information based on the current transmission coordinate; and
a controller configured to:
receive a simulation of a target object,
generate a power map of the target object based on the simulation,
identify sub-regions of the target object based on the power map,
calculate, based on the power map, a set of optical gain values, including a respective optical gain value for each sub-region, and
adjust, based on the transmission coordinate information, the optical gain on a dynamic basis by setting the optical gain to an optical gain value, from the set of optical gain values, that is associated with a sub-region that corresponds to the current transmission coordinate indicated by the transmission coordinate information.

16. The beam scanning system of claim 1, further comprising:
a position tracking circuit configured to monitor a current transmission coordinate of the beam scanner and generate transmission coordinate information based on the current transmission coordinate; and
a controller configured to:
perform an initial scan of a target object to obtain a power map of the target object,
identify, based on the power map, sub-regions of the target object,
calculate, based on the power map, a set of optical gain values, including a respective optical gain value for each sub-region, and
adjust, based on the transmission coordinate information, the optical gain on a dynamic basis by setting the optical gain to an optical gain value, from the set of optical gain values, that is associated with a sub-region that corresponds to the current transmission coordinate indicated by the transmission coordinate information.

17. The beam scanning system of claim 1, further comprising:
a controller configured to adjust the optical gain on a dynamic basis,
wherein the transmitter is configured to transmit a preliminary light beam prior to transmitting the light beam,
wherein the detector is configured to acquire an initial measurement of a preliminary reflected light beam corresponding to the preliminary light beam, and
wherein the controller is configured to, based on the initial measurement, adjust the optical gain to an adjusted optical gain value such that the gain-compensated light beam is within the dynamic range of the one or more sensor elements.

18. The beam scanning system of claim 1, further comprising:
a controller configured to adjust the optical gain on a dynamic basis,
wherein the light beam is a continuous-wave light beam,
wherein the detector is configured to acquire an initial measurement of the reflected light beam corresponding to a first segment of the continuous-wave light beam,
wherein the controller is configured to, based on the initial measurement, adjust the optical gain to an adjusted optical gain value such that the gain-compensated light beam is within the dynamic range of the one or more sensor elements, and
wherein the detector is configured to acquire a measurement of the gain-compensated light beam that corresponds to the adjusted optical gain value, the measurement corresponding to a second segment of the continuous-wave light beam.

19. A method of beam scanning, comprising:
transmitting, by a light transmitter, a light beam;
directing, by a beam scanner, the light beam along a transmission path according to a two-dimensional (2D) scanning pattern;
receiving, by a receiver, a reflected light beam that corresponds to the light beam transmitted by the light transmitter;
applying, by an optical preamplifier of the receiver, an optical gain to the reflected light beam to produce a gain-compensated light beam; and
acquiring, by a detector of the receiver, measurements of the gain-compensated light beam,
wherein applying the optical gain includes applying the optical gain to the reflected light beam such that the gain-compensated light beam is within a dynamic range of the detector.

20. The method of claim 19, further comprising:
filtering, by a narrow band pass filter arranged between the optical preamplifier and the detector, out broadband noise from the gain-compensated light beam, the broadband noise being produced by the optical preamplifier.

21. The method of claim 19, wherein applying the optical gain to the reflected light beam includes adjusting the optical gain on a dynamic basis based on a power map of a target object.

22. The method of claim 19, further comprising:
monitoring a current transmission direction of the beam scanner,
wherein applying the optical gain to the reflected light beam includes adjusting the optical gain on a dynamic basis based on the current transmission direction and based on a power map of a target object.

23. The method of claim 19, further comprising:
transmitting, by the light transmitter, a preliminary light beam or a preliminary portion of the light beam;
obtaining, by the detector, an initial measurement of a reflection of the preliminary light beam or the preliminary portion of the light beam; and
adjusting, by a controller, the optical gain of the optical preamplifier based on the initial measurement such that the gain-compensated light beam is within the dynamic range of the detector.
